(19) United States
(12) Patent Application Publication
(10) Pub. No.: US 2003/0212803 A1
(43) Pub. Date: Nov. 13, 2003

(54) Real time streaming media communication system with improved session detail collection systems and methods

(75) Inventors: Jianmin Wu, San Jose, CA (US); Chih-Ping Lee, Cupertino, CA (US)

Correspondence Address: TIMOTHY P. O'HAGAN, 8710 KILKENNY CT, FORT MYERS, FL, 33912, US

(73) Assignee: Innomedia Pte Ltd., The Alpha (SG)

(21) Appl. No.: 10/142,322

(22) Filed: May 9, 2002

(51) Int. Cl. G06F 15/16

(52) U.S. Cl. 709/228

(57) ABSTRACT

A real time streaming media session client operates with a communication service provider system. The client generates a session signaling message to the system identifying an endpoint and receives a response message. The response message includes an endpoint address for the real time streaming media session. The client commences a real time streaming media session with destination address. The client periodically sends session status responses to the system in response to session status requests sent by the system. The client also terminates the session and reports the session termination time along with a session identifier to the system in response to a call detail record backup request by the system.

### TECHNICAL FIELD

The present invention relates to real time streaming media communications over a broad band packet switched network, and in particular to systems and methods for collection of session detail records.

### BACKGROUND OF THE INVENTION

For many years voice telephone service was implemented over a circuit switched network commonly known as the public switched telephone network (PSTN) and controlled by a local telephone service provider. In such systems, the analog electrical signals representing the conversation are transmitted between the two telephone handsets on a dedicated twisted-pair-copper-wire circuit. More specifically, each telephone handset is coupled to a local switching station on a dedicated pair of copper wires known as a subscriber loop. When a telephone call is placed, the circuit is completed by dynamically coupling each subscriber loop to a dedicated pair of copper wires between the two switching stations.

More recently, the copper wires, or trunk lines between switching stations have been replaced with fiber optic cables. A computing device digitizes the analog signals and formats the digitized data into frames such that multiple conversations can be transmitted simultaneously on the same fiber. At the receiving end, a computing device reforms the analog signals for transmission on copper wires. Twisted pair copper wires of the subscriber loop are still used to couple the telephone handset to the local switching station.

More recently yet, voice telephone service has been implemented over the Internet. Advances in the speed of Internet data transmissions and Internet bandwidth have made it possible for telephone conversations to be communicated using the Internet's packet switched architecture and the TCP/IP protocol.

Software is available for use on personal computers which enable the two-way transfer of real-time voice information via an Internet data link between two personal computers (each of which is referred to as an end point or client). Each end point computer includes appropriate hardware for driving a microphone and a speaker. Each end point operates simultaneously both as a sender of real time voice data and as a receiver of real time voice data to support a full duplex voice conversation. As a sender of real time voice data, the end point computer converts voice signals from analog format, as detected by the microphone, to digital format. The software then facilitates data compression down to a rate compatible with the end point computer's data connection to an Internet Service Provider (ISP) and facilitates encapsulation of the digitized and compressed voice data into a frame compatible with the user datagram protocol and internet protocol (UDP/IP) to enable communication to the other end point via the Internet.

As a receiver of real time voice data, the end point computer and software reverse the process to recover the analog voice information for presentation to the operator via the speaker associated with the receiving computer.

Additionally, voice over Internet protocol (VOIP) telephone appliances have been developed that incorporate hardware and software circuits as well as the microphone and speaker into a device with a typical telephone form factor and user interface for voice service over the Internet.

To promote the wide spread use of Internet telephony, the International Telephony Union (ITU) had developed a set of standards for Internet telephony. The ITU Q.931 standard relates to call signaling and set up, the ITU H.245 standard provides for negotiation of channel usage and compression capabilities between the two endpoints, and the ITU H.323 standard provides for real time voice data between the two end points to occur utilizing UDP/IP to deliver the real time voice data.

Additionally, the Internet Engineering Task Force (IETF) has developed a set of standards for initiating real time media data sessions known as the Session Initiation Protocol (SIP). SIP provides for UDP/IP messages to be exchanged between the two endpoints (or between the two endpoints and multiple proxy servers) to provide for call signaling and negotiation of compression capabilities.

An ISP may charge the customer for data Internet access and for VOIP telephone using different billing schemes. Typically data Internet access is charged at a flat rate for unlimited use over a period of time. However, VOIP telephone usage is typically charged per unit of time of actual usage. Because an ISP providing VOIP telephone service may provide systems and methods for reserved bandwidth on its physical network for the streaming media data representing VOIP telephone calls, the price differential may be market justified.

A problem associated with Internet telephony is that the streaming media is sent peer-to-peer between the two VOIP devices and an accounting server that tracks usage is notified of a VOIP call only during call set up and call tear down. Various system failures and various acts that can be performed by the user of a VOIP system can prevent reporting of a call tear down to the accounting server. As such, the accounting server can not calculate call duration for billing purposes.

### SUMMARY OF THE INVENTION

A first aspect of the present invention is to provide a communication service provider accounting server for use in tracking communication session usage by a client of the service provider. The accounting server comprises means for receiving an indication identifying a client that has commenced a communication session and means for receiving an indication that the client has terminated the communication session from a proxy server. The accounting server also comprises means for sending a sequence of periodic session status request messages to the client and receiving a sequence of session status response messages from the client, a response message in response to each of the sequence of periodic request messages.

The accounting server determines a session termination time, the session termination time being the earlier: of receipt of the indication that the client has terminated the communication session; and determination that the sequence of status messages have ceased.

The accounting server also determines session a session commencement time, the session commencement time being the time at which the accounting server receives the indication identifying a client that has commenced a communication session. The accounting server may provide both the session commencement time and session termination time (along with a session ID and other useful information for billing the session) to a session detail record.

The accounting server may further yet comprises means for sending a sending a session detail backup request message to the client and receiving a session detail record backup response message from the client. The session detail backup message may identify the session and include session detail record backup information such as a client measured session termination time. The accounting server may update the session detail record to indicate that the session terminated at the client measured session termination time if the client measured session termination time and the session termination time are not approximately the same.

Another aspect of the present invention is to provide a real time streaming media session client for operation with a communication service provider system. The client comprises: a) means for generating a session signaling message to the system identifying an endpoint; b) means for receiving a response message in response to the session signaling message, the response including a destination address for the real time streaming media session; c) means for commencing a real time streaming media session with the endpoint; and d) means for terminating the real time streaming media session.

The client further comprises means for receiving a sequence of session status request from the accounting server and responding to each session status request with a session status response message.

The client further comprises means for storing session detail backup records which may include a session identifier, the session commencement time and the session termination time (as measured by the client). The client may receive a call detail record backup request from the accounting server and may report the session detail backup records to the accounting server in response thereto.

For a better understanding of the present invention, together with other and further aspects thereof, reference is made to the following description, taken in conjunction with the accompanying drawings, and its scope will be pointed out in the appended clams.

### BRIEF DESCRIPTION OF THE DRAWINGS

FIG. 1 is a block diagram representing real time media communications in accordance with one embodiment of this invention;

FIG. 2a is a block diagram representing messaging for establishing a real time communication session in accordance with one embodiment of this invention;

FIG. 2b is a block diagram representing messaging for terminating a real time communication session in accordance with one embodiment of this invention;

FIG. 3 is a flow chart representing operation of a proxy server in accordance with one embodiment of the present invention;

FIG. 4 is a flow chart representing operation of an accounting server in accordance with one embodiment of the present invention; and

FIG. 5 is a flow chart representing operation of a client in accordance with one embodiment of the present invention

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code, or a combination of a hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of a hardware circuit(s) and a processor and/or control block executing code.

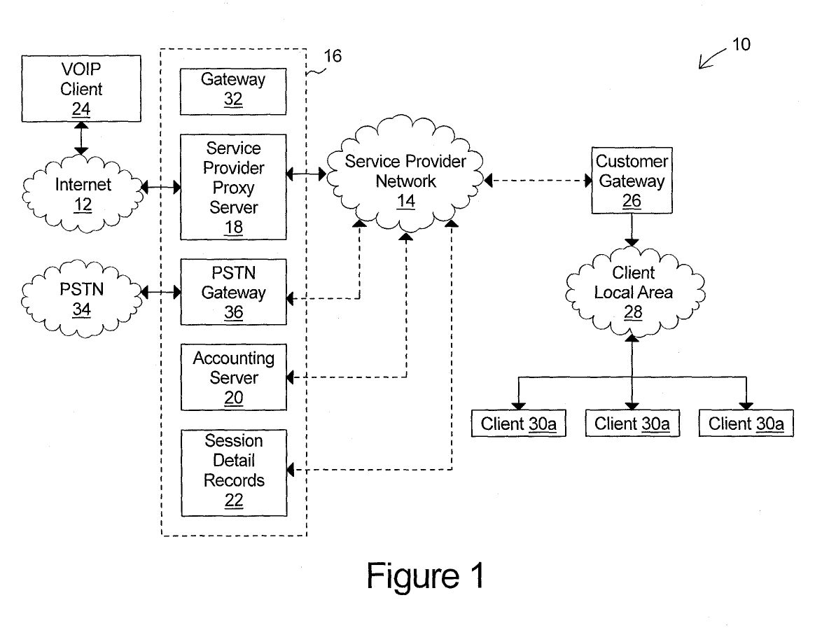

Referring now to FIG. 1, a packet switched service provider network 14 interconnects service provider gateway system 16 with a customer gateway 26. The service provider gateway system 16 may be coupled to the Internet 12 and the public switched telephone network (PSTN) 34.

The customer gateway 26 interconnects a customer local area network 28 with the service provider network 14. The customer gateway 26 may operate as a router that provides for each customer client 30a, 30b, and 30c to obtain an IP address from the service provider system 16 and for general operation of the customer local area network 28 as a subnet of the service provider network 14.

Alternatively, the customer gateway 26 may operate as a network address translation server (NAT server) communicating frames over the service provider network 12 on behalf of the clients 30a, 30b, and 30c that are coupled to the local area network 28. In which case, the customer gateway 26 may include proprietary predefined ports available to permit the service provider gateway system 16 to send unsolicited frames to each of the VOIP clients 30a, 30b, and 30c to enable inbound call signaling.

Each VOIP client 30a, 30b, and 30c may be a VOIP telephony device that exchanges real time streaming media (audio and video) with a remote endpoint utilizing TCP/IP connections and/or UDP/IP channels. Additionally, each VOIP client 30a, 30b, and 30c may include an audio system with a speaker and microphone for translating an audio conversation to VOIP frames or may include a PSTN conversion circuitry that translates between VOIP frames and analog or digital PSTN signals for supporting a traditional telephone device.

As such, the service provider gateway system 16 may provide Internet data connection services and virtual subscriber loop telephone communication services to the customer.

In the exemplary embodiment, the service provider network 14 may be a hybrid fiber/cable (HFC) network over which data may be exchanged between the service provider gateway system 16 and the customer gateway 26 utilizing a predetermined protocol. An exemplary protocol would include one of the versions of the Data Over Cable Service Interface Specification (DOCSIS) published by Cable Television Laboratories, Inc. 400 Centennial Parkway, Louisville, Colo. 80027-1266, U.S.A.

The predetermined protocol utilized for communications between the service provider gateway 16 and the customer gateway 10 supports higher level protocols for providing the Internet connection service and virtual subscriber loop telephone service.

For providing Internet connection service, the network protocol may support the Internet Protocol (IP) suite such that the customer gateway 26 may communicate with other IP compliant devices coupled to the Internet 12.

For providing virtual subscriber loop telephone service (both audio and audio/video), the network protocol may support a real time media protocol such as the PacketCable protocol published by Cable Television Laboratories, Inc. operating over the IP suite to dynamically reserve bandwidth on the service provider network 14 and maintain a real time audio (or audio/video) communication session with an endpoint telephone system on the PSTN 34 or the Internet 12.

The service provider gateway system 16 may comprises a gateway 32, a service provider VOIP proxy server 18, a PSTN gateway 36, an accounting server 20, and session detail records 22.

The gateway 32 may operate as a router of IP frames between devices coupled to the service provider network 14 and the Internet 12. The service provider proxy server 18 may operate as a session initiation protocol (SIP) proxy for facilitating call signaling and real time streaming media communication session set up between a VOIP client (such as VOIP clients 30a, 30b, and 30c) coupled to the service provider network 14 and a remote Internet client 24. Operation of the proxy 18 server is discussed in more detail herein.

The PSTN gateway 36 may translate a telephone session between a PSTN endpoint coupled to the PSTN 34 and a VOIP client (such as VOIP clients 30a, 30b, and 30c) coupled to the service provider network 14. As such, the PSTN gateway 36 may operate as a VOIP endpoint for establishing and maintaining a VOIP session with the VOIP client and may operate as a PSTN endpoint for establishing and maintaining a PSTN session with the remote PSTN endpoint.

The accounting server 20 receives signals from the proxy server 18 indicating the commencement and termination of each VOIP session and stores a session commencement time and session termination time (as well as other session details) in the session detail records. As such, the service provider may bill for VOIP sessions based on the duration of each session. A more detailed discussion of the accounting server is included herein.

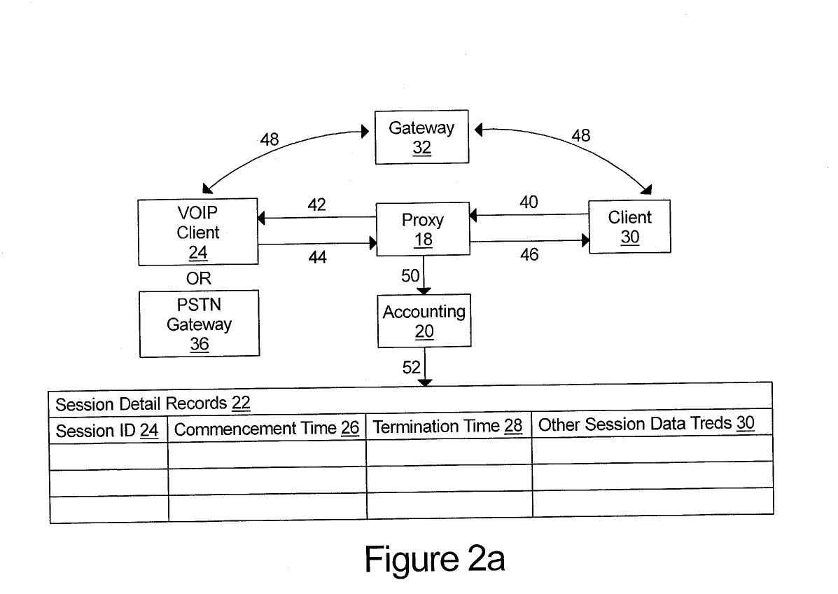

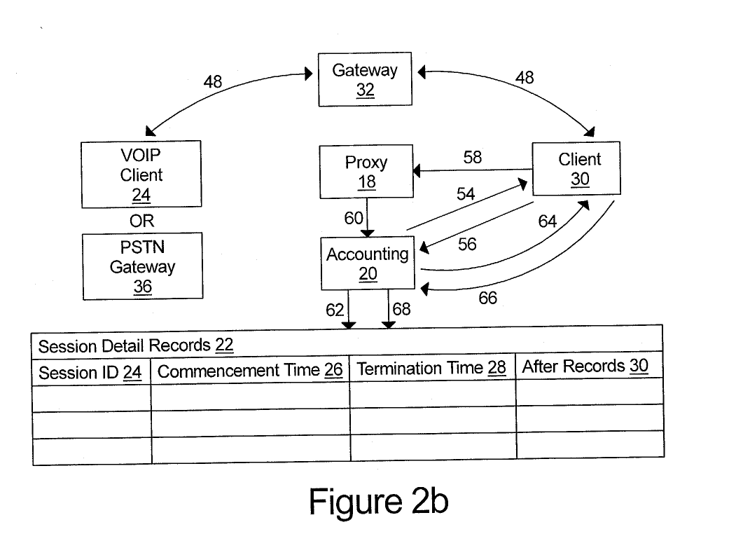

The block diagram of FIG. 2a represents messaging that may be utilized to establish a VOIP session between a client 30 and a destination endpoint that may be either a remote VOIP client 24 coupled to the Internet 12 (FIG. 1) or to the PSTN gateway (for translating to a PSTN session to a remote PSTN telephone).

To initiate a session, the client 30 sends a session signaling message 40 (such as an SIP Invite message) to the proxy server 18. The session signaling message 40 may include its own client identification (such as its own SIP URL) and an endpoint identifier that identifies the endpoint (such as the endpoint SIP URL). After receipt of the session signaling message 40, the proxy server 18 looks up the network address of the endpoint using the endpoint identifier and sends a session signaling message 42 to the endpoint.

Following receipt of the session signaling message 42, the endpoint may provide an alert message back to the proxy server 18 indicating that the endpoint is in an alert state whereby it is generating an audio and/or visual ring or alert signal to alert the user to an inbound session request. Such an alert message may be a SIP 180 Ringing message. The proxy server 18 may provide a similar alert message to the client 30.

Following the operator responding to the alert signal (e.g. answering the ringing telephone), the endpoint may provide a response message (such as a SIP 200 OK message) 44 to the proxy server 18. The response message 44 may include the address of the endpoint such that the client 30 may establish the communication session to the endpoint (discussed herein). The address may be included in a SIP Contact Field.

Upon receipt of the response message from the endpoint, the proxy server 18 may provide a similar response message 46 back to the client 30. The similar response message 46 may include both the address of the endpoint and a SIP Record—Route Field to indicate to the client 30 that further SIP signaling should be completed utilizing the proxy server 18 rather than directly to the endpoint.

After receiving the response message 46, the client 30 and the endpoint establish a peer-to-peer real time streaming media communication session 48 (utilizing the gateway 32 if the endpoint is a VOIP client 24).

Along with providing the response message 46, the proxy server 18 further provides a message 50 to the accounting server 20 that identifies the session, identifies the client 30 (including network address of the client 30), and identifies the endpoint. The message 50 may also identify the time of the response signal 44 and/or the time of the response signal 46 as the approximate time of the commencement of the communication session 48.

If the proxy server 18 and the accounting server 20 are operated on the same server hardware, the message 50 may be sent utilizing application to application messaging techniques. Alternatively, if the proxy server 18 and the accounting server 20 are operating on separate server systems interconnected by a network, the message 50 may be sent over the network utilizing applicable network signaling protocols. The message 50 may use any messaging format compatible with both the proxy server 18 and the accounting server 20 such a pre-defined file structure or XML using predefined data tags.

Following receipt of the message 50, the accounting server 20 will provide a message 52 including the session details to the session detail records 22. The message 52 may represent writing session details directly to the session detail records 22 or may represent providing the session details in a compatible message format to a session detail records server which in turn will write the session details to the session detail records 22.

The session detail records 22 may include a session ID field 24, a session commencement time field 26, and a session termination time field 28 as well as other session data fields that may include information about the session useful for billing purposes.

The block diagram of FIG. 2b represents messaging that may be utilized to assure that an accurate session termination time is recorded in the termination time field 28 of the session detail records 22.

As discussed, the real time streaming media communication session is a peer-to-peer session 48 between the client 30 and the endpoint. Throughout the session 48, the accounting server 20 periodically sends a session status request 54 to the client 30 and the client 30 responds to the accounting server 20 with a session status response message 56 (which may identify the communication session and indicate that the communication session remains in progress). The purpose of the session status request message 54 and the session status response message 56 are to provide the accounting server 20 with a time frame of when (if at all) the client 30 malfunctions, disconnects from the service provider network 14 (FIG. 1) or otherwise becomes incapable of network communications (that may include becoming incapable of maintaining the peer-to-peer session 48, receiving the session status request 54, and/or responding 56 to the session status request 54).

In the event that the client 30 fails to respond to the session status request message 54 after a predetermined time out, the accounting server 20 will determine that the last session status response 56 received from the client 30 represents the termination time of the communication session 48 and will send a message 62 that includes the session termination time to the session detail records 22.

Assuming that the client does respond to all session status request messages 54, the peer-to-peer communication session 48 may be terminated by the client 30 or the endpoint with a termination message 58 such as a SIP Bye message. Because the response message 46 (during the communication session set up) included the Record Route Field, the termination message 58 will be sent to the proxy server 18.

In response to the termination message 58, the proxy server 18 will provide a message 60 to the accounting server 20 identifying the communication session and indicating the termination time. In response to the message 60, the accounting server will send the message 62 that includes the session termination time to the session detail records 22.

It should be appreciated that the accounting server determines a session termination time by either failure to receive a response to a session status message 54 or receipt of a message indicating termination of the session 60. As such, the session termination time is the earlier of receipt of the indication that the client has terminated the communication session, and determination that the sequence of status messages has ceased.

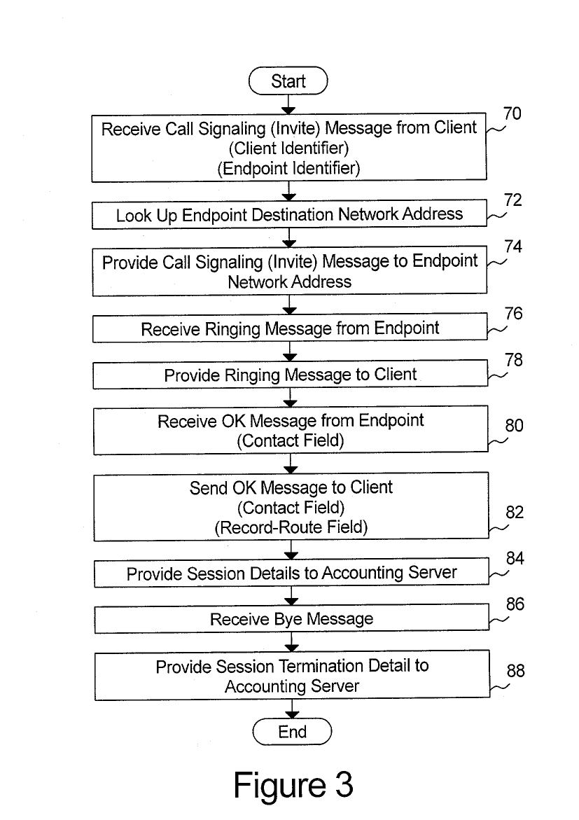

Referring to FIG. 3 in conjunction with FIGS. 2a and 2b, operation of the proxy server 18 is discussed in more detail. Step 70 represents receiving a call session signaling message 40 from the client. Step 72 represents looking up the network address of the endpoint and step 74 represents providing the endpoint signaling message 42 to the endpoint. Step 76 represents receiving an alert message from the endpoint indicating that it is in an alert state and step 78 represents providing an alert message to the client 30 indicating that the endpoint is in an alert state. Step 80 represents receiving the response signal 44 from the endpoint. The response signal 44 may include a SIP Contact field such, that when provided to the client 30, the client 30 may initiate the peer-to-peer communication session 48 directly to the endpoint. Step 82 represents sending the similar response signal 46 to the client 30. The similar response signal may include the Record-Route field to assure that further messages, including the session termination message 58, are provide to the proxy server 18. Step 84 represents providing the session detail message 50 to the accounting server.

Step 86 represents receiving the session termination message 58 from the client 30 following termination of the communication session 48. Step 88 represent providing the session termination message 60 to the accounting server.

While it should be appreciated that the proxy server 18 may perform other functions to facilitate establishing and terminating a communication session between a client 30 and an endpoint, the above described steps are the steps that relate to the embodiments of the invention described herein.

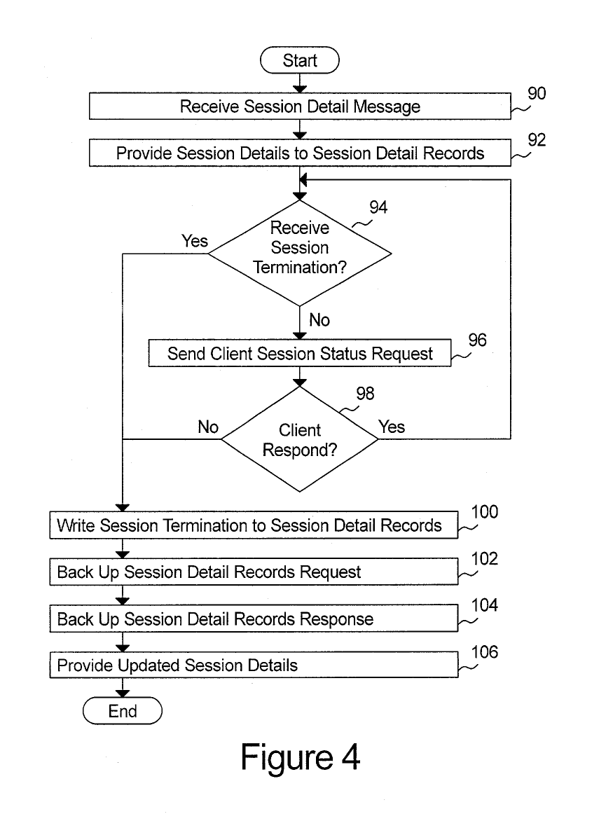

Referring to FIG. 4 in conjunction with FIGS. 2a and 2b, operation of the accounting server 20 is discussed in more detail. Step 90 represents receiving the session detail message 50 at the commencement of the communication session 48. Step 92 represents providing message 52 to the session detail records 22. Step 94 represents a determination whether a message 60 indicating termination of the communication session 48 has occurred. If a message 60 is received at step 94, the accounting server advances to step 100 which represents providing message 62 to the session detail records.

Alternatively, if a message 60 is not received at step 94, the accounting server provides the first of a series of periodic session status request messages 54 to the client 30 at step 96. Step 98 represents a determination whether the client 30 provides a response message 56 in response to the session status request message 54 within a predetermined timeout window. If there is a response message 56, the accounting server again returns to steps 94 and 96 where additional periodic session status messages 54 are sent until either the message 60 indicating session termination is received from the proxy server 18 or the client 30 fails to provide a response message 56. If the client 30 fails to provide a response message 56 at step 98, the accounting server again proceeds to step 100 wherein the message 62 is provided to the session detail records.

Following step 100, at a future time, the accounting server 20 will provide a backup session detail records request 64 to the client 30 at step 102 and receive the backup session detail records response 66 from the client 30. If the backup records indicating that an incorrect session termination time (e.g. session termination time does not match a client measured session termination time as provided to the accounting server 20 in the session detail records response 66) may have been provided to the session detail records 22, the accounting server 106 will provide the message 68 that includes updated session detail to the session detail records 22 at step 106.

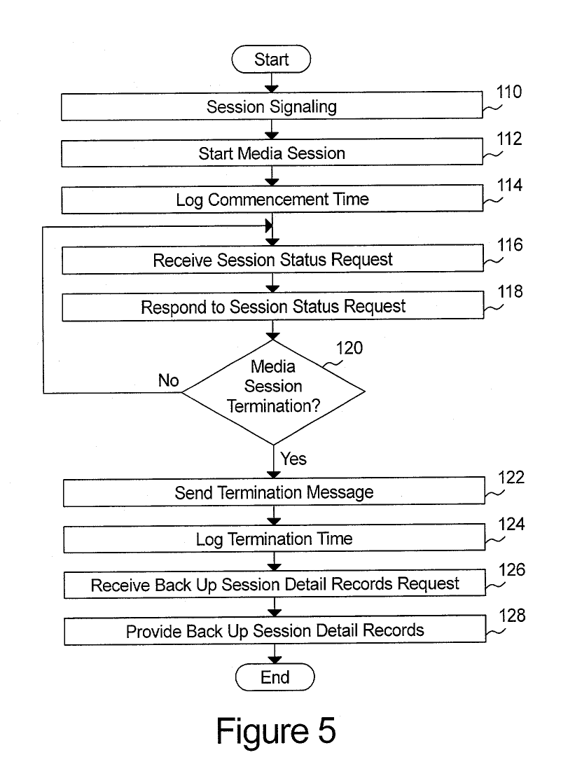

Referring to FIG. 5 in conjunction with FIGS. 2a and 2b, operation of the client 30 is discussed in more detail. Step 110 represents sending the initial session signaling message 40 to the proxy server 18 and step 112 represents starting the communication session 48 with the endpoint. Step 114 represents logging the commencement time in a session detail backup file in association with a session identifier.

As discussed, during the course of the communication session 48, the accounting server will send periodic session status request messages 54. Step 116 represents receiving such a message. In response thereto, step 118 represents providing the response message 56.

Step 120 represents a determination if the communication session 48 is ready for termination (e.g. users ready to disconnect). If not, steps 116 and 118 will be continued to be repeated so long as session status request messages 54 are received. If the communication session 48 is ready for termination, step 122 represents sending the termination message 58 and step 124 represents logging the termination time (e.g. client measured session termination time) in the session detail backup file.

At some future time, the backup session detail records request 64 may be received from the accounting server 20. Step 126 represents receipt of such request and step 128 represents providing the response 66 that may include the session commencement time, the session termination time, the session ID, and other session details that may be useful for billing purposes at step 128.

It should be appreciated that the systems and methods discussed herein provide for more accurate detection of communication session details than known systems. In particular, the system and methods provide for more accurate determination of a communication session termination time than known systems.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A real time streaming media session client for operation with a communication service provider system, the client comprising:
means for generating a session signaling message to the system identifying an endpoint;
means for receiving a response message in response to the session signaling message, the response including a destination address for the real time streaming media session;
means for commencing a real time streaming media session with the endpoint;
means for terminating the real time streaming media session;
means for storing a session termination time in association with a session identifier;
means for reporting the session identifier and the session termination time to the system.

2. The client of claim 1, further comprising:
means for storing a session commencement time, in response to commencing a real time streaming media session with the endpoint; and
the means for reporting the session identifier and the session termination time to the system further comprises means for reporting the session commencement time.

3. The client of claim 1, further comprising:
means for receiving a call detail record backup request from the system; and
the means for reporting the session identifier and the session termination time to the system operates in response to the call detail record backup request.

4. The client of claim 1, further comprising:
means for periodically sending a session status message to the system during the session.

5. The client of claim 4, further comprising:
means for receiving a session status request from the system; and
the means for sending the session status message to the system operates in response to receiving a session status request from the system.

6. A real time streaming media session client for operation with a communication service provider system, the client comprising:
means for generating a session signaling message to the system identifying an endpoint;
means for receiving a response message in response to the session signaling message, the response including an endpoint address for the real time streaming media session;
means for commencing a real time streaming media session with the endpoint;
means for periodically sending a session status message to the system during the session.

7. The client of claim 6, wherein the session status message includes a session identifier.

8. The client of claim 6, further comprising:
means for receiving a session status request from the system; and
the means for sending the session status message to the system operates in response to receiving a session status request from the system.

9. The client of claim 6, further comprising:
means for storing a session termination time in association with a session identifier;
means for reporting the session identifier and the session termination time to the system.

10. The client of claim 9, further comprising:
means for storing a session commencement time, in response to commencing a real time streaming media session with the endpoint; and
the means for reporting the session identifier and the session termination time to the system further comprises means for reporting the session commencement time.

11. The client of claim 9, further comprising:
means for receiving a call detail record backup request from the system; and
the means for reporting the session identifier and the session termination time to the system further comprises operates in response to the call detail record backup request.

12. A real time streaming media communication method by a client operating with a communication service provider system, the method comprising:
generating a session signaling message to the system identifying an endpoint;
receiving a response message in response to the session signaling message, the response message including an endpoint address for the real time streaming media session;
commencing a real time streaming media session with the endpoint;
terminating the real time streaming media session;
storing a session termination time in association with a session identifier; and
reporting the session identifier and the session termination time to the system.

13. The method of claim 12, further comprising:
storing a session commencement time, in response to commencing a real time streaming media session to the endpoint; and
the step of reporting the session identifier and the session termination time to the system further comprises reporting the session commencement time.

14. The method of claim 12, further comprising:
receiving a call detail record backup request from the system; and
the step of reporting the session identifier and the session termination time to the system is in response to receiving the call detail record backup request.

15. The method of claim 12, further comprising:
periodically sending a session status message to the system during the session.

16. The method of claim 15, further comprising:
receiving a session status request from the system; and
the step of periodically sending the session status messages to the system comprises sending a session status message in response to each received session status request from the system.

17. A real time streaming media communication method by a client operating with a communication service provider system, the method comprising:
generating a session signaling message to the system identifying an endpoint;
receiving a response message in response to the session signaling message, the response including an endpoint address for the real time streaming media session;
commencing a real time streaming media session with the destination address;
periodically sending a session status message to the system during the session.

18. The method of claim 17, wherein the session status message includes asession identifier.

19. The method of claim 17, further comprising:
receiving a session status request from the system; and
the step of periodically sending the session status messages to the system comprises sending a session status message in response to each session status request from the system.

20. The method of claim 17, further comprising:
terminating the real time streaming media session;
storing a session termination time in association with a session identifier;
reporting the session identifier and the session termination time to the system.

21. The method of claim 20, further comprising:
storing a session commencement time, in response to commencing a real time streaming media session with the destination device; and
the step of reporting the session identifier and the session termination time to the system further comprises reporting the session commencement time.

22. The method of claim 20, further comprising:
receiving a call detail record backup request from the system; and
the step of reporting the session identifier and the session termination time to the system further is in response to the call detail record backup request.
